(19) United States
(12) Patent Application Publication
(10) Pub. No.: US 2013/0048704 A1
(43) Pub. Date: Feb. 28, 2013

(54) ARTICLE-TRANSPORT CONTAINER

(71) Applicants: William H. Lewis, Goodyear, AZ (US); William P. Gnann, Salinas, CA (US); Julianne J. Geiger, San Juan Bautista, CA (US); Michael B. McLeod, Romeoville, IL (US)

(72) Inventors: William H. Lewis, Goodyear, AZ (US); William P. Gnann, Salinas, CA (US); Julianne J. Geiger, San Juan Bautista, CA (US); Michael B. McLeod, Romeoville, IL (US)

(21) Appl. No.: 13/597,378

(22) Filed: Aug. 29, 2012

Related U.S. Application Data
(60) Provisional application No. 61/529,133, filed on Aug. 30, 2011.

(51) Int. Cl. B65D 5/20; B31B 3/00

(52) U.S. Cl. 229/190; 493/52

(57) ABSTRACT

A container is adapted to transport food or other articles. The container includes a floor, two end walls coupled to the floor, a left closure coupled to the end walls and the floor, and a right closure coupled to the end walls and the floor.

### PRIORITY CLAIM

This application claims priority under 35 U.S.C. §119(e) to U.S. Provisional Application Ser. No. 61/529,133, filed Aug. 30, 2011, which is expressly incorporated by reference herein.

### BACKGROUND

The present disclosure relates to trays and containers, and particularly to trays and containers made of paperboard. More particularly, the present disclosure relates to a sturdy tray or container made of corrugated material and configured to contain food or other items.

### SUMMARY

An article-transport container or tray is adapted to transport food or other articles from one site to another. The container includes a floor, a left-side closure, a right-side closure, a front end wall coupled to the floor and to the two closures, and a rear end wall coupled to the floor and to the two closures. These walls and closures cooperate to form an interior article-receiving region.

In illustrative embodiments, the left-side closure includes an inner side wall coupled to the floor about a left-side fold line, an outer side wall coupled to the inner side wall about a side-wall fold axis, and a first crush zone. The first crush zone is configured to provide means for interconnecting the outer side wall to the inner side wall to cause the outer side wall to fold about the side-wall fold axis toward the floor of the container to cause a flat, uniform support surface to be established along portions of the side-wall fold axis so that a floor of a second container may be supported on the flat uniform support surface without causing leaning of the second container.

In illustrative embodiments, the first crush zone includes a first crush web. The first crush web is arranged to lie between and interconnect the inner and outer side walls.

In illustrative embodiments, the inner side wall and the outer side wall have a corrugated thickness. The first crush web has a relatively smaller crushed thickness that causes the first crush web to elongate and thin in response to folding of the outer side wall about the side-wall fold axis relative to the inner side wall during forming of the container.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of an erected article-transport container including several crush zones in accordance with the present disclosure showing the food-transport container includes, in series, starting in the front left, a front end closure coupled to a floor included in the container, a left side closure coupled to the floor and including a pair of spaced-apart stack tabs extending upwardly, a rear end closure coupled to the floor, and a right side closure coupled to the floor and including another pair of stack tabs extending upwardly;

FIG. 2 is an enlarged partial perspective view of the left-rear corner of the container of FIG. 1 showing a first crush zone formed along a support surface included in the left side closure of the container, a second crush zone formed between an inner-wall anchor flap included in the left side closure and an outer-wall anchor flap (not shown) included in the left side closure and shown in FIG. 3, a third crush zone formed along a fold line formed between an outer side wall included in the left side closure and the outer-wall anchor flap, a fourth crush zone formed along a top surface of the stack tab included in the left side closure, and a fifth crush zone formed around a perimeter of a tab aperture;

FIGS. 2A-2C are a series of diagrammatic views showing establishment of the second crush zone during formation of a corrugated blank in a blank-forming process;

FIG. 2A is a diagrammatic view showing an initial phase of blank forming in which a corrugated sheet passes into a die included in a corrugated-material forming machine and showing that the die includes a material-cutting blade that cuts through the corrugated sheet as suggested in FIG. 2B and a pair of material-crushing bars positioned on both sides of the material-cutting blade that flattens the corrugated sheet so that the second crush zone is established as suggested in FIG. 2C;

FIG. 2B is a view similar to FIG. 2A showing an intermediate phase of blank forming in which the die of the corrugated-cutting machine engages the corrugate sheet to cut the corrugated sheet using the material-cutting blade and to crush the corrugated sheet using the pair of material-crushing bars so that the corrugated blank is formed as suggested in FIG. 2C;

FIG. 2C is a view similar to FIG. 2B showing a final phase of blank forming in which the die of the corrugated-cutting machine has moved away from the newly formed corrugated blank and showing that the corrugated blank includes the second crush zone;

FIG. 3 is a plan view of a blank of corrugated material used to form the container of FIG. 1 and showing that the blank includes a floor, an unfolded left side closure (at the top of the page) including an inner strip coupled to the floor and an outer strip coupled to the inner strip, an unfolded rear end closure (at the right side of the page), an unfolded right side closure (at the bottom of the page) including an inner strip and an outer strip, and an unfolded front end closure (at the left side of the page);

FIG. 4 is an enlarged partial plan view of the unfolded left side closure of FIG. 3 showing that the unfolded left side closure includes the inner strip that includes, in series from left to right, an auxiliary inner-wall anchor flap, an inner side wall coupled to the floor, and the inner-wall anchor flap, and an outer strip that includes, in series from left to right, an auxiliary outer-wall anchor flap, an outer side wall coupled to the inner side wall, and the outer-wall anchor flap, and showing that the first crush zone is formed along a side-wall folding axis centered between the inner side wall and the outer side wall, the second crush zone is formed between the inner-wall anchor flap and the outer-wall anchor flap, the third crush zone is formed between the inner side wall and the inner-wall anchor flap, the fourth crush zone is formed and centered between an outer section of a T-shaped tab strip included in the outer side wall and an inner section of the T-shaped tab strip, and a fifth crush zone formed along a perimeter of a T-shaped tab-strip aperture formed during erection of the container as suggested in FIGS. 6-9;

FIG. 5 is an enlarged partial plan view of the unfolded right side closure of FIG. 3 showing that unfolded right side closure includes the inner strip that includes, in series from left to right, an auxiliary inner-wall anchor flap, an inner side wall coupled to the floor, and the inner-wall anchor flap, and an outer strip that includes, in series from left to right, an auxiliary outer-wall anchor flap, an outer side wall coupled to the inner side wall, and the outer-wall anchor flap, and showing that the first crush zone is centered between the inner side wall and the outer side wall, the second crush zone is formed between the inner-wall anchor flap and the outer-wall anchor flap, the third crush zone is formed between the inner side wall and the inner-wall anchor flap, the fourth crush zone is centered between an outer section of a T-shaped tab strip included in the outer side wall and an inner section of the T-shaped tab strip, and a fifth crush zone formed along a perimeter of a T-shaped tab-strip aperture formed during erection of the container as suggested in FIGS. 6-9;

FIGS. 6-9 are a series of views showing a method of erecting the article-transport container of FIG. 1 using the blank of FIG. 3;

FIG. 6 is a perspective view of the blank of FIG. 3 being folded to erect the left side closure and the rear end wall and showing that initial erecting of the container includes the steps of separating outer sections of the T-shaped tab strips from the T-shaped tab apertures, folding the rear end wall about a rear-end fold line and at the same time folding upwardly the left side closure about the left-side fold line, folding the inner-wall anchor flap about an inner-wall anchor-flap fold line toward the rear end wall, and folding the outer wall anchor flap about the outer-wall anchor-flap fold line away from the inner-wall anchor flap so that after erection of the container, the rear end wall will be located between the outer-wall anchor flap and the inner-wall anchor flap as suggested in FIG. 9;

FIG. 7 is a view similar to FIG. 6 showing continued erecting of the container by continuing to fold the inner strip upwardly about the left-side fold line until the inner strip extends vertically upward from the floor, continuing to fold the outer strip about the side-wall fold axis toward the floor to trap an outer section of the T-shaped tab strip between the inner and outer side walls so that a folded stack tab is formed upon erection of the container as suggested in FIG. 9, folding the inner-wall anchor flap about the inner-wall anchor-flap fold line until the inner-wall anchor flap is in confronting relation with the rear end wall, and keeping the outer-wall anchor flap folded back out of the way so that the left-rear corner of the container is established as suggested in FIGS. 8 and 9;

FIG. 8 is a view similar to FIGS. 6 and 7 showing continued erecting of the container by continuing to fold the outer strip about the side-wall fold axis toward the inner strip until the inner-wall anchor-flap fold line is seated in the left-rear corner of the container and the rear end wall is trapped between the inner and the outer anchor flaps as shown in FIG. 9;

FIG. 9 is a view similar to FIGS. 6-8 showing completed folding of the left side closure and suggesting folding of the right side closure;

FIGS. 10-15 are a series of views showing how the first crush zone functions during folding of the outer side wall about the side-wall folding line as shown in FIGS. 6-9;

FIG. 10 is a sectional view taken along line 10-10 of FIG. 4 showing the first crush zone during an initial stage of erecting the left side closure of the container in which a first crush web interconnects the inner and outer side walls and has a first length and a first thickness;

FIG. 11 is a diagrammatic illustration showing, from top to bottom, the first thickness and the first length of the crush web during the initial stage of erecting the left side closure as shown in FIG. 10;

FIG. 12 is a sectional view taken along line 12-12 of FIG. 6 showing the first crush zone during an intermediate stage of erecting the left side closure in which the first crush web has begun to deform and elongate causing the first crush web to have a relatively smaller second thickness and a relatively larger second length as a result of the outer side wall being folded along the side-wall fold axis relative to the inner side wall;

FIG. 13 is a view similar to FIG. 11 showing that the first crush web has the relatively smaller second thickness and relatively longer length during the intermediate stage of erecting the left side closure as shown in FIG. 12;

FIG. 14 is a sectional view taken along line 14-14 of FIG. 9 showing the first crush zone during a final stage of erecting the left side closure in which the first crush web has further deformed and elongated causing the first crush web to have a relatively smaller third thickness and a relatively larger third length;

FIG. 15 is a diagrammatic illustration showing, from top to bottom, the relatively smaller third thickness and the relatively larger third length of the first crush web during the final stage of erecting the left side closure as shown in FIG. 14;

FIG. 16 is an enlarged partial perspective and diagrammatic view of the inner and outer strips showing how the second crush zone functions during an initial stage of erecting the rear end closure in which a first portion of a second crush web is formed on the outer-wall anchor flap and a second portion of the second crush web is formed on the inner-wall anchor flap so that friction developed between the inner-wall and outer-wall anchor flaps during erection of the rear end closure is minimized as suggested in FIG. 17;

FIG. 17 is a view similar to FIG. 16 showing an intermediate stage of erecting the rear end closure in which the inner-wall anchor flap has pivoted upwardly about an inner-wall anchor-flap fold line away from the outer-wall anchor flap so that the rear end wall may be positioned between the inner-wall and outer-wall anchor flaps as shown in FIG. 8;

FIGS. 18-22 are a series of views showing how the third crush zone functions during folding of the outer-wall anchor flap about the outer-wall anchor flap fold line to form an inner rear-left corner of the container as shown in FIGS. 6-9;

FIG. 18 is an enlarged partial perspective view of the inner rear-left corner of the container showing initial formation of the inner left-rear corner of the article-transport container by folding the inner-wall anchor flap in a clockwise direction about the inner-wall anchor-flap fold line toward the rear end wall and folding the outer-wall anchor flap in a counter-clockwise direction about the angled outer-wall anchor flap fold line so that the rear end wall is trapped between the inner-wall and outer-wall anchor flaps as suggested in FIG. 20;

FIG. 19 is a view similar to FIG. 18 showing continued folding of the inner strip about the side-wall fold axis relative to the outer strip;

FIG. 20 is a view similar to FIGS. 18 and 19 showing completed formation of the inner left-rear corner of the container is achieved by trapping the rear end wall between the inner-wall and outer-wall anchor flaps;

FIG. 21 is a sectional view taken along line 21-21 of FIG. 20 showing that the third crush zone allows folding of the outer-wall anchor flap about the outer-wall anchor flap fold line relative to the outer side wall without binding and showing that the outer-wall anchor flap fold line causes a folding gap to be established between the outer-wall anchor flap and the rear end panel that grows from a relatively narrow width at a top end of the inner left-rear corner to a relatively larger width at a bottom end of the inner left-rear corner as suggested in FIG. 22;

FIG. 22 is a sectional view taken along line 22-22 of FIG. 20 showing that the folding gap has increased at the bottom end of the inner left-rear corner as a result of the outer-wall anchor-flap fold line being arranged to lie at an acute angle relative to the side-wall fold axis as shown in FIGS. 3 and 4;

FIGS. 23-26 are a series of views suggesting how the fourth crush zone functions during folding of the outer section of the T-shaped tab strip about a tab-fold axis relative to an inner section of the T-shaped tab strip to form a stack tab and showing how the fifth crush zone functions during formation of the stack tab to minimize binding between the T-shaped tab strip and the T-shaped tab-aperture formed in the outer wall;

FIG. 23 is an enlarged partial perspective view of a portion of the outer side wall showing the T-shaped tab strip formed as a result of cutting the T-shaped tab aperture in the outer side wall and showing that the fourth crush web is centered between outer and inner sections of the T-shaped tab strip as shown in FIGS. 6-8 and the fifth crush web is formed around the T-shaped tab aperture so that friction developed between the T-shaped tab strip and the outer side wall is minimized during formation of the stack tab as shown in FIGS. 6-9 and suggested in FIG. 25;

FIG. 24 is a sectional view taken along line 24-24 of FIG. 23 showing the fourth crush web interconnecting the outer section of the T-shaped tab strip and the inner section of the T-shaped tab strip along the tab-fold axis and showing the fifth crush web formed around the T-shaped tab-strip aperture;

FIG. 25 is a view similar to FIG. 23 showing movement of the outer section of the T-shaped tab strip out of the T-shaped tab strip aperture relative to the inner section of the T-shaped tab strip during formation of the left side closure; and

FIG. 26 is a sectional view taken along line 26-26 of FIG. 25.

### DETAILED DESCRIPTION

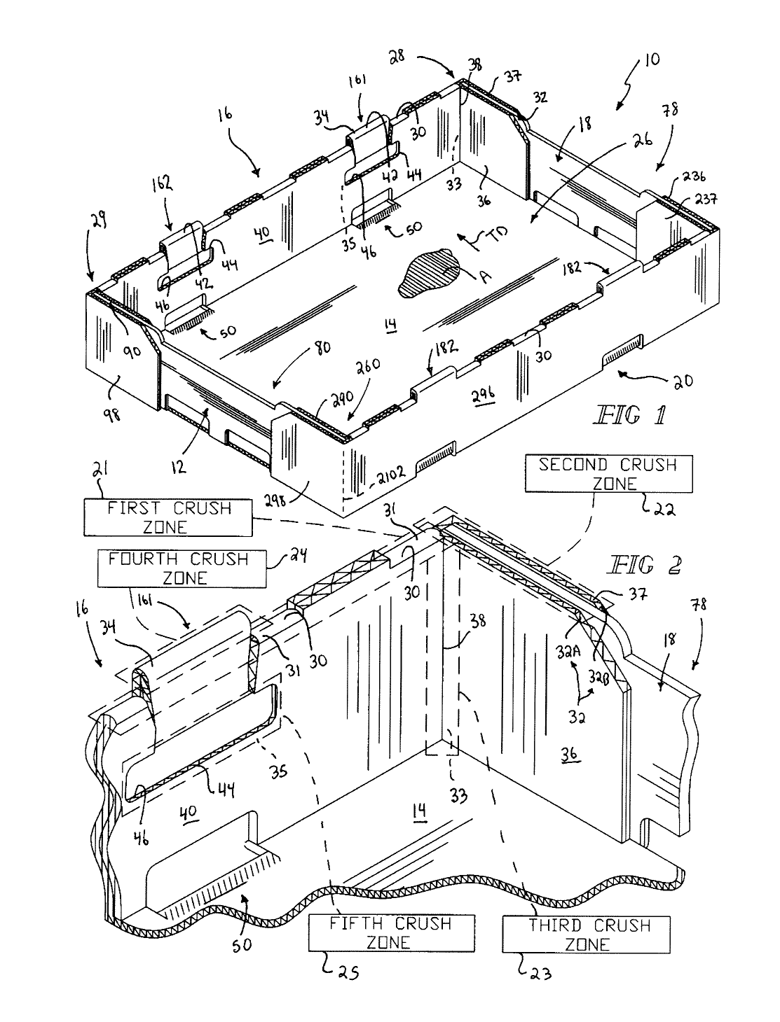

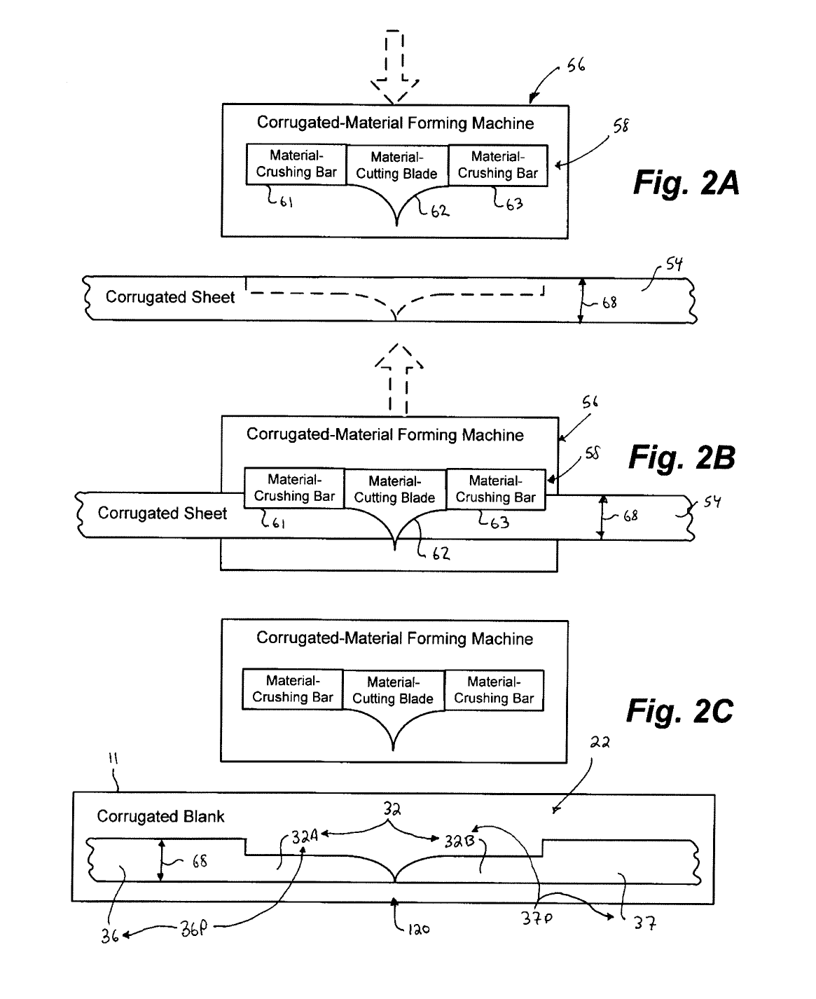

An erected article-transport container 10 in accordance with the present disclosure is shown in FIG. 1. Article-transport container 10 includes several crush zones 21, 22, 23, 24, and 25 as shown in FIG. 2. Article-transport container 10 includes, in series starting in the front left, a front end wall 12 coupled to a floor 14 included in container 10, a left side closure 16 coupled to floor 14 and including a pair of stack tabs 161, 162, a rear end wall 18 coupled to floor 14, and a right side closure 20 coupled to floor 14 and including another pair of stack tabs 181, 182. Front end wall 12, left side closure 16, rear end wall 18, right side closure 20, and floor 14 cooperate to define an interior region 26 therebetween that is adapted to receive articles (not shown) therein.

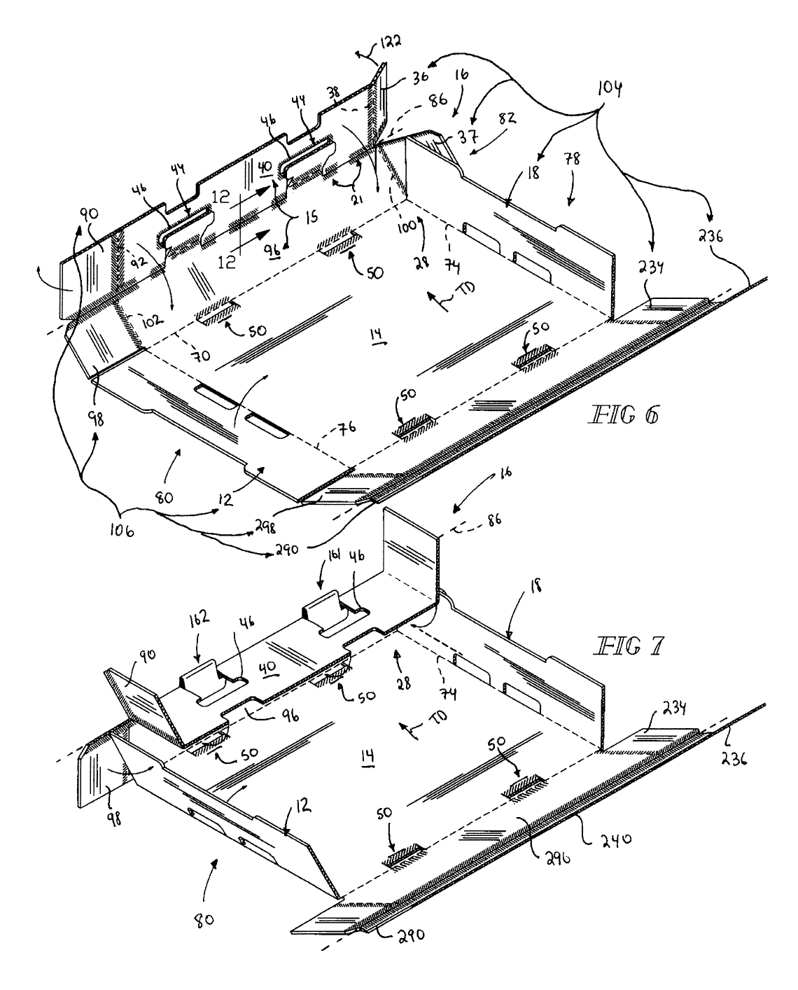

Article-transport container 10 is established as result of passing a blank 11 through a container-erection process as shown in FIG. 6-9. Blank 11 is established as a result of a blank-forming process suggested in FIGS. 2A-2C. During the blank-forming process, a corrugated sheet is cut to produce floor 14, front end wall 12, a left side panel 15 including an inner side wall 96 that is coupled to the floor and an outer side wall 40 that is coupled to the inner side wall 96, rear end wall 18, and a right side panel 17 including an inner side wall 296 that is coupled to floor 14 and an outer side wall 240 that is coupled to inner side wall 296.

The blank-forming process further includes means for deforming left side panel 15 to produce a relatively thicker inner side wall 96 coupled to floor 14, a relatively thicker outer side wall 40 coupled to inner side wall 96, and a relatively thinner first crush web 31 that is arranged to lie between and to interconnect inner and outer side walls 96, 40 to cause outer side wall 40 to pivot about a side-wall fold axis 86 during folding of the container so that a relatively flat and uniform support surface 30 is established. As shown in FIG. 2, means for deforming left side panel 15 establishes first crush zone 21 along side-wall fold axis 86.

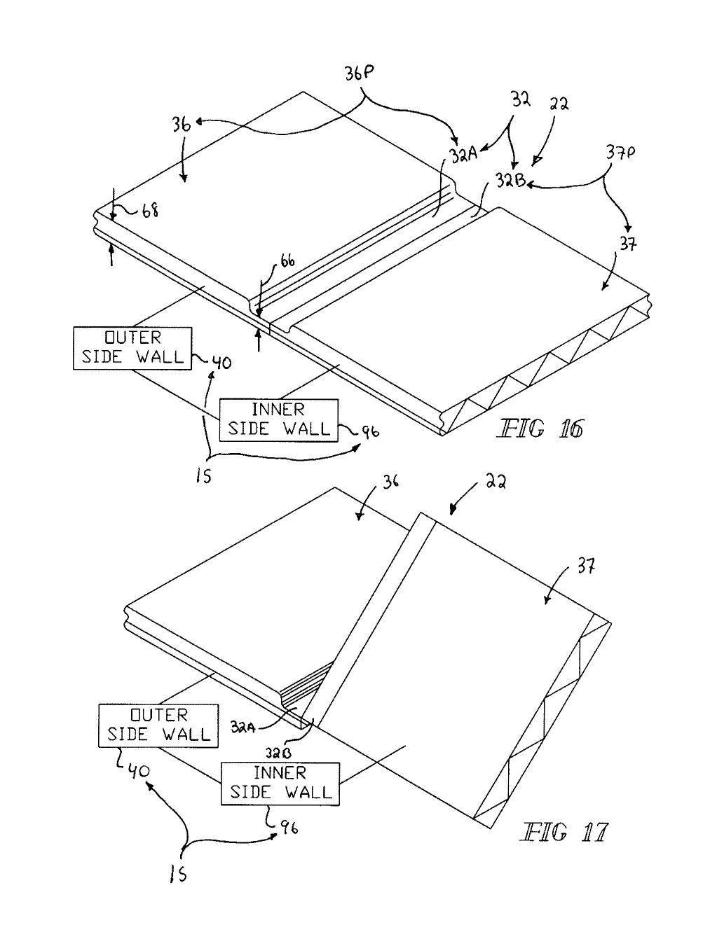

The blank-forming process also includes means for deforming left side panel 15 to produce a relatively thicker inner-wall anchor flap 37 coupled to inner side wall 96, a relatively thicker outer-wall anchor flap 36, and a relatively thinner second crush web 32 and substantially simultaneously cutting second crush web 32 to produce a cut line 120 that extends through the second crush web to form an outer-wall flap panel 36P that includes relatively thicker outer-wall anchor flap 36 and a first crush-web portion 32A and an inner-wall flap panel 37P that includes relatively thicker inner-wall anchor flap 37 and a second crush-web portion 32B so that friction between the inner-wall and outer-wall flap panels 36P, 37P is minimized during forming of the container as suggested in FIG. 2C and shown in FIGS. 16 and 17. As shown in FIG. 2, means for deforming and cutting left side panel 15 establishes second crush zone 22 along cut line 120.

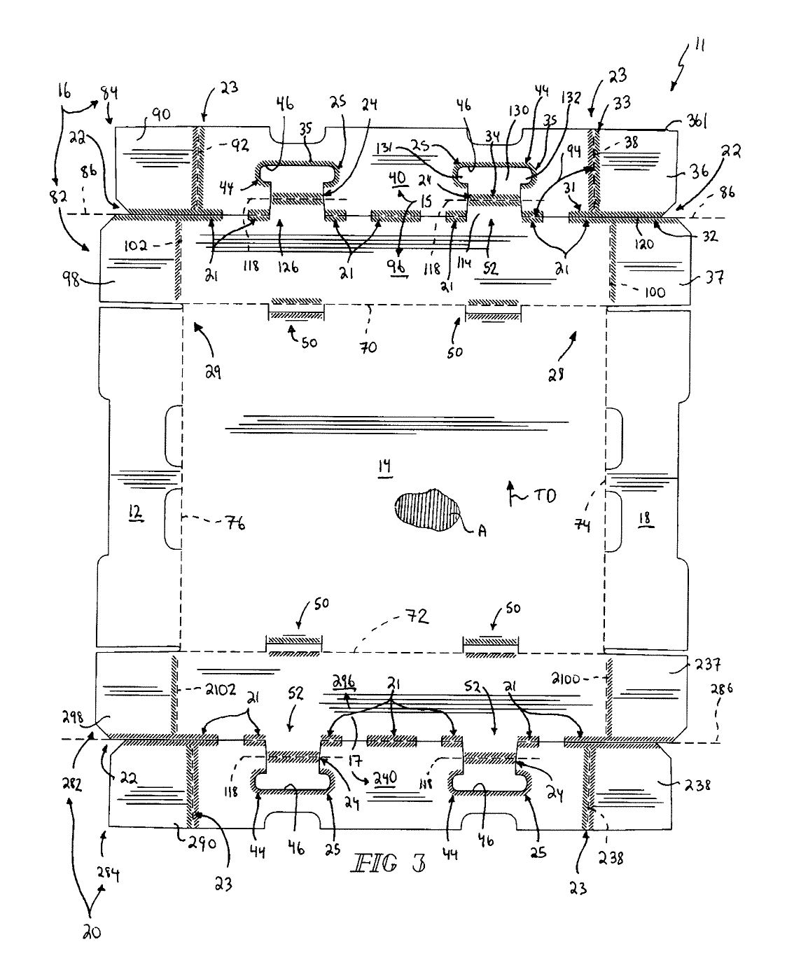

The blank-forming process further includes means for deforming outer strip 84 to produce relatively thicker outer side wall 40 coupled to inner side wall 96, relatively thicker outer-wall anchor flaps 36, 90, and relatively thinner third crush web 33 that interconnect each outer-wall anchor flap 36, 90 to outer side wall 40 along associated outer-wall anchor-flap fold lines 38, 92 so that resistance to folding outer-wall anchor flaps 36, 90 about associated outer-wall anchor-flap fold lines 38, 92 is minimized. As shown in FIGS. 2 and 3, means for deforming outer strip 84 establishes third crush zone 23 along outer-wall anchor-flap fold lines 38, 92.

The blank-forming process also includes means for deforming a tab strip 52 to produce a relatively thicker outer section 116, a relatively thicker inner section 114, and a fourth crush web 34 that interconnects inner and outer sections 114, 116 along a tab-fold axis 118 to cause a top surface 42 of first stack tab 161 to be established during container forming that is relatively flat and uniform so that stack tab 161 mates with an associated stack-tab receiver 50 formed in a floor included in a second container stacked on container 10. As shown in FIG. 2, means for deforming tab strip 52 establishes fourth crush zone 24 along tab-fold axis 118.

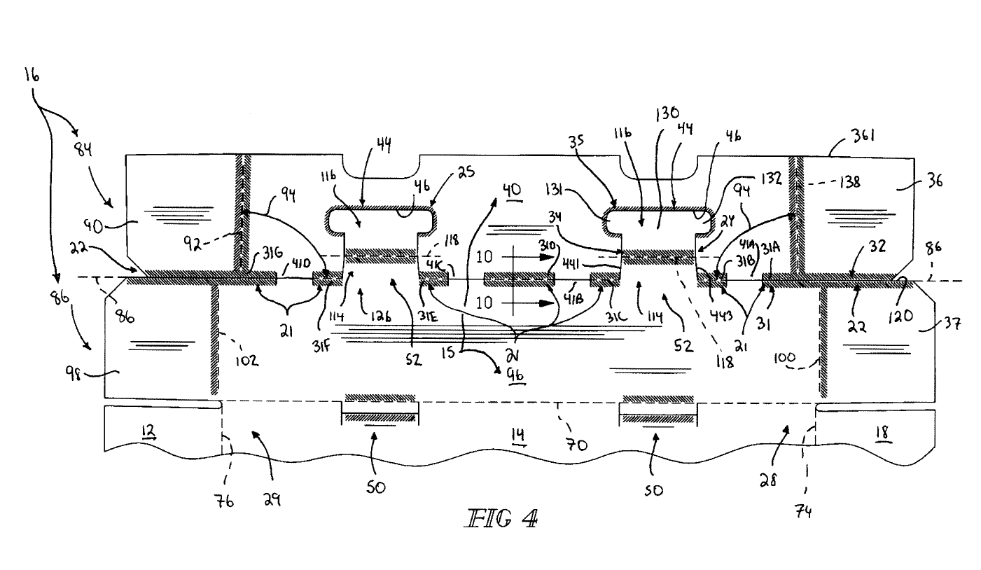

The blank-forming process also includes means for deforming outer side wall 40 to produce a relatively thinner perimeter 44 formed around a tab aperture 46 so that friction between tab strip 52 of left side closure 16 and tab aperture 46 formed in left side closure 16 is minimized. As shown in FIGS. 3 and 4, means for deforming outer side wall 40 establishes fifth crush zone 25 around perimeter 44 of tab aperture 46.

First, second, third, fourth, and fifth crush zone 21, 22, 23, 24, and 25 are included in a left-rear corner 28 of container 10 as shown in FIG. 2. Left-rear corner 28 of container 10 is formed as a result joining left side closure 16, right side closure 20, and rear end wall 18 as suggested in FIGS. 6-9.

As an example, second crush zone 22 is formed during an illustrative blank-forming process shown in FIGS. 2A-2C. The blank-forming process includes an initial phase shown in FIG. 2A, and intermediate phase shown in FIG. 2B, and a final phase shown in FIG. 2C.

During the initial phase of the container-forming process, a corrugated sheet 54 is moved into position in a corrugated-material forming machine 56 so that a die 58 included in corrugated-material forming machine 56 may engage corrugated sheet 54 as suggested in FIG. 2B. During the intermediate phase, die 58 engages corrugated sheet 54 to cut and crush a portion of corrugated sheet 54 so that second crush zone 22 is formed as a result as shown in FIG. 2C. During the final phase, die 58 moves out of engagement with corrugated sheet 54 and a corrugated blank 11 exits corrugated-material forming machine 56. Corrugated blank 11 may be folded during a container forming process to establish container 10 as shown in FIGS. 6-9.

Die 58 of corrugated-material forming machine 56 includes, for example, a material-cutting blade 64 and first and second material-crushing bars 61, 62 as shown in FIGS. 2A-2C. Material-cutting blade 64 cuts through corrugated sheet 54 to form a cut line 120. As shown in FIG. 4, cut line 120 is an anchor-flap cut line 120 which is between inner-wall anchor flap 37 and outer-wall anchor flap 36. Material-crushing bars 61, 62 are arranged to locate material-cutting blade 64 therebetween and are configured to flatten corrugated sheet 54 to cause the corrugated sheet directly below material-crushing bars 61, 62 to have a crushed thickness 66 which less than a corrugated thickness 68 that is present outside of crush zones 21, 22, 23, 24, and 25. First, third, fourth, and fifth crush zones 21, 23, 24, 25 are formed as a result of other dies included in corrugated-material forming machine 56 having various other combinations and arrangements of material-cutting blades and material-crushing bars. As an example, material-crushing bars 61, 62 may be made of hard rubber, cork, metal or other suitable material.

In an illustrative embodiment, the corrugation of blank 11 is positioned to run in a transverse direction TD as shown in insert A in FIGS. 1 and 3. It is within the scope of the present disclosure to establish each of the fold lines disclosed herein by using score lines, creases, perforations, or perforations and score lines or by using another suitable technique.

Container 10 is made from blank 11 after blank 11 is formed by corrugated-material forming machine 56. As shown in FIG. 3, blank 11 includes floor 14, left side closure 16 appended to floor 14 along a left-side fold line 70, right side closure 20 appended to floor 14 along a right-side fold line 72, rear end wall 18 appended to floor 14 along a rear-end fold line 74, and front end wall 12 appended to floor 14 along a front-end fold line 76. Right side closure 20, left side closure 16, rear end wall 18, and front end wall 12 cooperate to form a border coupled to floor 14 and arranged to cooperate with floor 14 to define interior region 26 of container 10.

Rear end wall 18 cooperates with left side closure 16 and right side closure 20 to establish a rear end 78 of container 10 as shown in FIGS. 1 and 2 and as suggested in FIGS. 6-9. Front end wall 12 cooperates with left side closure 16 and right side closure 20 to establish a front end 80 of container 10 as shown in FIGS. 1 and 2 and suggested in FIG. 6-9. It is within the scope of the present disclosure to make blank 11 from a variety of materials including corrugated paperboard, folding carton, and solid fiber and other materials such as plastic sheeting and plastic corrugated.

Left side closure 16 includes an inner strip 82 and an outer strip 84 as shown in FIGS. 3 and 4. Inner strip 82 is appended to floor 14 along left-side fold line 70. Outer strip 84 is appended to inner strip 82 along side-wall fold axis 86 as shown in FIG. 4.

Outer strip 84 includes outer-wall anchor flap 36, an outer side wall 40, and an auxiliary outer-wall anchor flap 90. Outer-wall anchor flap 36 is appended to outer side wall 40 along outer-wall anchor-flap fold line 38 as shown in FIGS. 3 and 4. As an example, outer-wall anchor-flap fold line 38 may be a perforated line or any other suitable line of weakness that is configured to promote folding there about. Auxiliary outer-wall anchor flap 90 is appended to outer side wall 40 opposite outer-wall anchor flap 36 along an auxiliary outer-wall anchor-flap fold line 92.

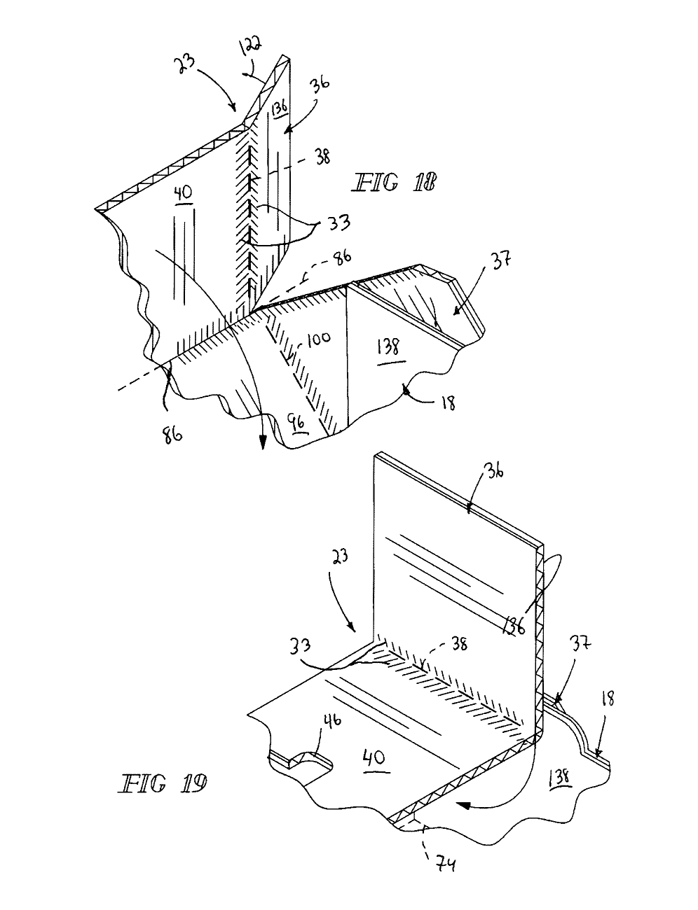

As shown in FIG. 4, outer-wall anchor-flap fold line 38 cooperates with side-wall fold axis 86 to define an angle 94 therebetween. As an example, angle 94 is an acute angle which is used during erection of container 10 to establish well-fit left-rear corner 28 of container 10 as suggested in FIGS. 18-22. As another example, angle 94 is less than about 89 degrees. Auxiliary outer-wall anchor-flap fold line 92 cooperates with side-wall fold axis 86 to define angle 94 therebetween which is also used during erection of container 10 to establish a well-fit left-front corner 29. As an example, acute angle 94 is about 89 degrees.

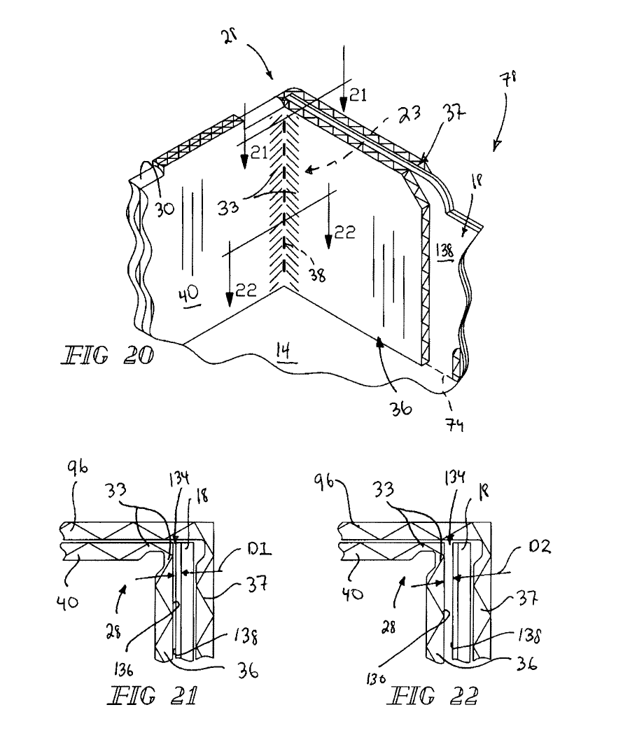

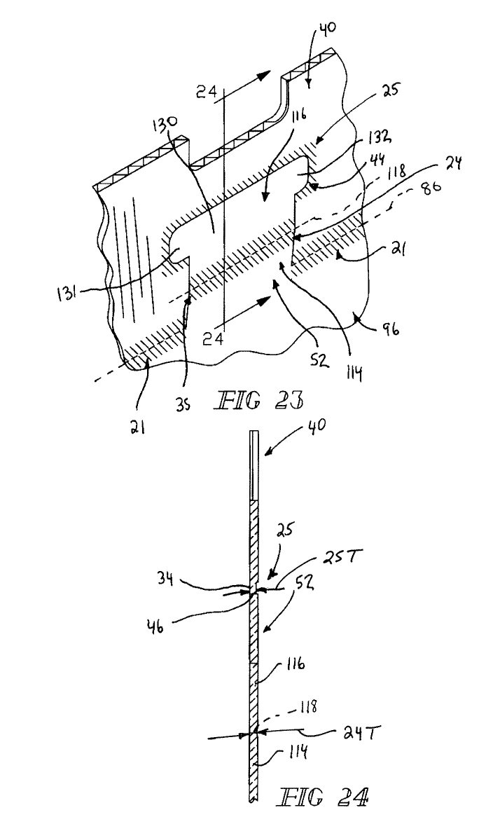

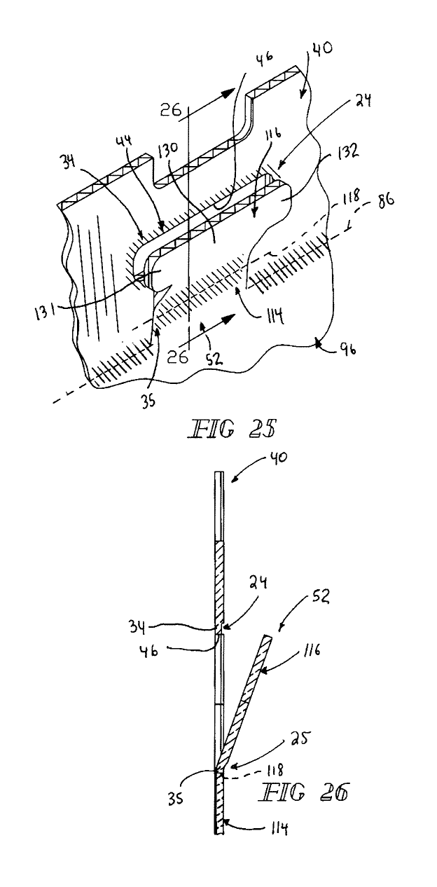

Outer-wall anchor-flap fold line 38 provides means for causing a gap 134 to be formed between outer-wall anchor flap 36 and rear end wall 18 to cause spatial relief to be established during container forming so that interference between rear end wall 18 and outer-wall anchor flap 36 is minimized. Gap 134 is defined by a first anchor-flap surface 136 of outer-wall anchor flap 36 that is arranged to face away from interior region 26 toward rear end wall 18 and a first rear-end-wall surface 138 that is arranged to face toward outer-wall anchor flap 36. As a result of outer-wall anchor-flap fold line 38 being arranged at an acute angle, gap 134 is tapered from a first distance D1 at a top of outer-wall anchor flap 36 to a relatively larger second distance D2 at a bottom of outer-wall anchor flap 36 as suggested in FIGS. 20-22.

Tapered gap 134 allows a maximized bond to be established between outer-wall anchor flap 36 and rear end wall 18 when glue is used for example. A bottom edge 361 of outer-wall anchor flap 36 may be arranged to cause an acute angle to be established between bottom edge 361 and outer-wall anchor-flap fold line 38 as suggested in FIG. 4. As a result, left side closure 16 and right side closure 20 may be arranged to tilt inwardly toward interior region 26 so that stacking tabs 161, 162, 181, 182 are aligned to be received in mating stack-tab receivers 50 formed in floor 14 of the container stacked on top of container 10.

Inner strip 82 of left side closure 16 includes inner-wall anchor flap 37, an inner side wall 96, and an auxiliary inner-wall anchor flap 98. Inner-wall anchor flap 37 is appended to inner side wall 96 along an inner-wall anchor-flap fold line 100 as shown in FIGS. 3 and 4. As an example, inner-wall anchor-flap fold line 100 may be a perforated line or any other suitable line of weakness that is configured to promote folding there about. Auxiliary inner-wall anchor flap 98 is appended to inner side wall 96 along auxiliary inner-wall anchor-flap fold line 102. Inner-wall anchor-flap fold lines 100, 102 are arranged, for example, to extend between and lie at about right angles to side-wall fold axis 86 and left-side fold line 70 as shown in FIGS. 3 and 4.

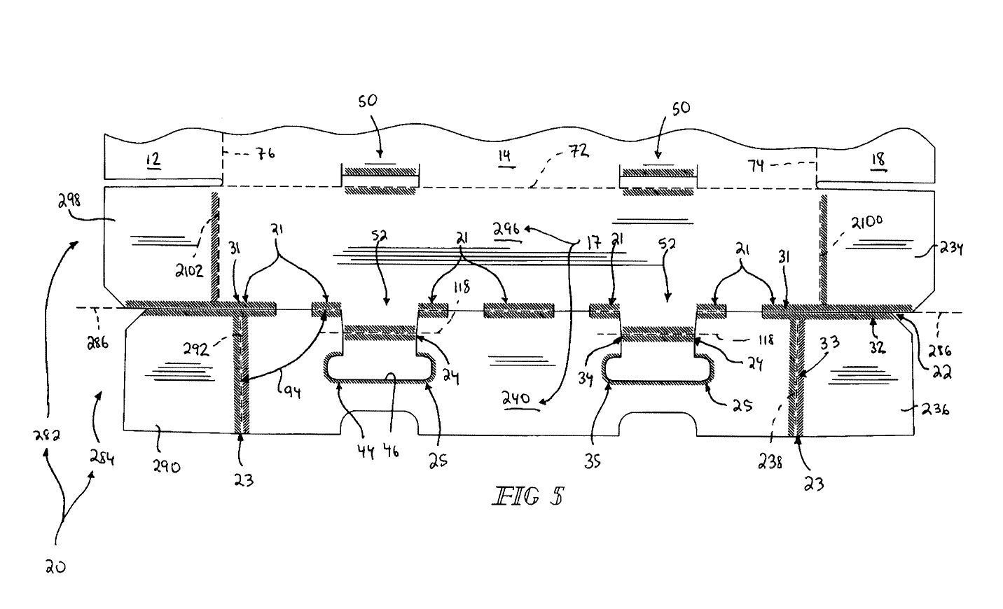

Right side closure 20 includes an inner strip 282 and an outer strip 284 as shown in FIGS. 3 and 5. Inner strip 282 is appended to floor 14 along right-side fold line 72. Outer strip 284 is appended to inner strip 282 along a side-wall fold axis 286.

Outer strip 284 of right side closure 20 includes outer-wall anchor flap 236, an outer side wall 240, and an auxiliary outer-wall anchor flap 290. Outer-wall anchor flap 236 is appended to outer side wall 240 along outer-wall anchor-flap fold line 238 as shown in FIGS. 3 and 5. Auxiliary outer-wall anchor flap 290 is appended to outer side wall 240 opposite outer-wall anchor flap 236 along an auxiliary outer-wall anchor-flap fold line 292.

As shown in FIG. 5, outer-wall anchor-flap fold line 238 cooperates with side-wall fold axis 286 to define angle 94 therebetween. Auxiliary outer-wall anchor-flap fold line 292 cooperates with side-wall fold axis 286 to define angle 94 therebetween which is also used during erection of container 10 to establish a well-fit right-front corner 260.

Inner strip 282 of right side closure 20 includes an inner-wall anchor flap 237, an inner side wall 296, and an auxiliary inner-wall anchor flap 298. Inner-wall anchor flap 237 is appended to inner side wall 296 along an inner-wall anchor-flap fold line 2100 as shown in FIGS. 3 and 5. Auxiliary inner-wall anchor flap 298 is appended to inner side wall 296 along auxiliary inner-wall anchor-flap fold line 2102. Inner-wall anchor-flap fold lines 2100, 2102 are arranged, for example, to extend between and lie at about right angles to side-wall fold axis 286 and right-side fold line 72 as shown in FIGS. 3 and 5.

A rear end closure 104 is formed during erection of container 10 as shown in FIGS. 6-9. Rear end closure 104 is formed as a result of rear end wall 18 being folded upwardly and positioned to lie between outer-wall anchor flaps 36, 236 and inner-wall anchor flaps 37, 237 as shown in FIG. 1 and suggested in FIG. 2. A front end closure 106 is also formed during erection of container 10 when front end wall 12 is positioned to lie between auxiliary outer-wall anchor flaps 90, 290 and auxiliary inner-wall anchor flaps 98, 298 as shown in FIG. 1.

In another embodiment, a rear end closure is formed as a result of inner-wall anchor flaps 37, 237 being arranged to lie between outer-wall anchor flaps 36, 236 and rear end wall. This rear end closure provides the container with an end surface that is arranged to lie in a single plane and face away from interior region 26.

Stack tab 161 is substantially the same as stack tabs 162, 181, and 182, and thus, only stack tab 161 will be discussed in detail. First stack tab 161 is formed during container forming by folding outer section 116 of tab strip 52 included in left side closure 16 inwardly towards floor 14 as shown in FIG. 6. Outer side wall 40 of left side closure 16 includes tab strip 52 and an auxiliary tab strip 126 as shown in FIGS. 3 and 4. Tab strip 52 is formed during the blank-forming process when a tab aperture 46 is cut in outer side wall 40. Outer side wall 240 of right side closure 20 includes tab strip 52 and auxiliary tab strip 126 as shown in FIGS. 3 and 5.

Tab strip 52 includes inner section 114 and outer section 116 as shown in FIGS. 3 and 4. Inner section 114 is appended to inner side wall 96. Outer section 116 is coupled to inner section 114. During container forming, inner side wall 96 is folded upwardly about left-side fold line 70 and outer section 116 of tab strip 52 is pushed inwardly toward floor 14 out of tab aperture 46 about tab-fold axis 118 relative to inner section 114 as shown in FIG. 6. As container forming continues, outer side wall 40 is folded about side-wall fold axis 86 toward floor 14 and outer section 116 is folded simultaneously toward floor 14 about tab-fold axis 118.

As shown in FIGS. 3-9, outer section 116 of tab strip 52 includes a body portion 130 and a pair of retention flanges 131, 132. Body portion 130 of outer section 116 is coupled to inner section 114 to fold about tab-fold axis 118. First retention flange 131 is appended to body portion 130 on a first side and second retention flange 132 is appended to body portion 130 on an opposite side. During forming of left side closure 16, retention flanges 131, 132 are trapped between inner side wall 96 and outer side wall 40 causing body portion 130 to fold about tab-fold axis 118. This type of stack tab is also called a trap tab.

In an another embodiment, retention flanges 131, 132 may be omitted and the outer section of the tab strip is coupled directly to the inner section during folding of the outer side wall relative to the inner side wall. As an example, the outer section may be retained in the folded position using glue or any other suitable means. This type of stack tab is also called a glue tab.

In still another embodiment, stack tabs may be only half the thickness of stack tab 161. As an example, a stack tab may be formed using only an inner section that is appended to the inner side wall. During container forming, the outer side wall is folded about the side-wall folding axis and the inner section remains extending upwardly while the outer side wall folds toward floor 14. In this embodiment, fourth crush zone 24 is not present as no folding of the tab strip occurs. However, fifth crush zone 25 remains and is used to minimize friction between the outer side wall and the tab strip during tray forming.

In still yet another embodiment, stack tabs may be omitted from the container so that the container may be used with a cover or lid. In this embodiment, both fourth and fifth crush zones 24, 25 are omitted as no stack tabs are present.

In one illustrative tray-forming process, container 10 is formed from blank 11 using a tray-forming machine to erect container 10 as suggested in FIGS. 6-9. In another illustrative tray-forming process, container 10 is formed from blank 11 using a manual process where an operator manually forms the tray. Crush zones 21, 22, 23, 24, and 25 cooperate together to aid both container-forming processes by maximizing repeatability of tray forming during either process so that stacked containers do become unstable and lean as a result of variability in the tray-forming process.

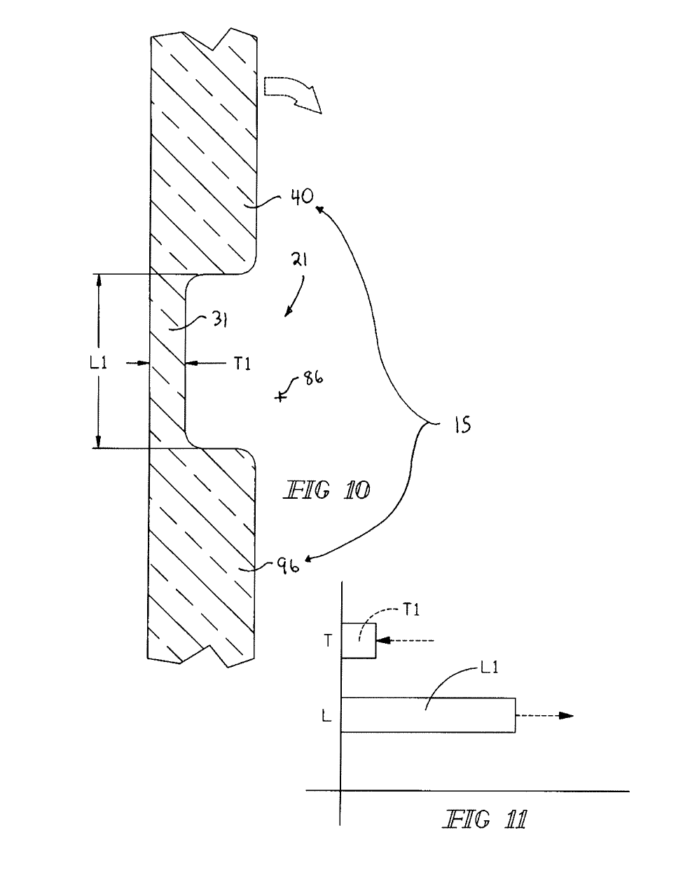

First crush zone 21 is established as a result of forming first crush web 31 during the blank-forming process. As illustrated in FIGS. 10-15, first crush web 31 is arranged to extend between and to interconnect inner side wall 96 and outer side wall 40. First crush web 31 is illustratively formed to have an initial first crush-web length L1 and an initial first crush-web thickness T1 during initial erecting of container 10 as shown in FIGS. 10 and 11. In comparison, inner side wall 96 and outer side wall 40 have corrugated thickness 68 which is greater than initial first crush-web thickness T1. First crush-web thickness T1 is about the same as crushed thickness 66.

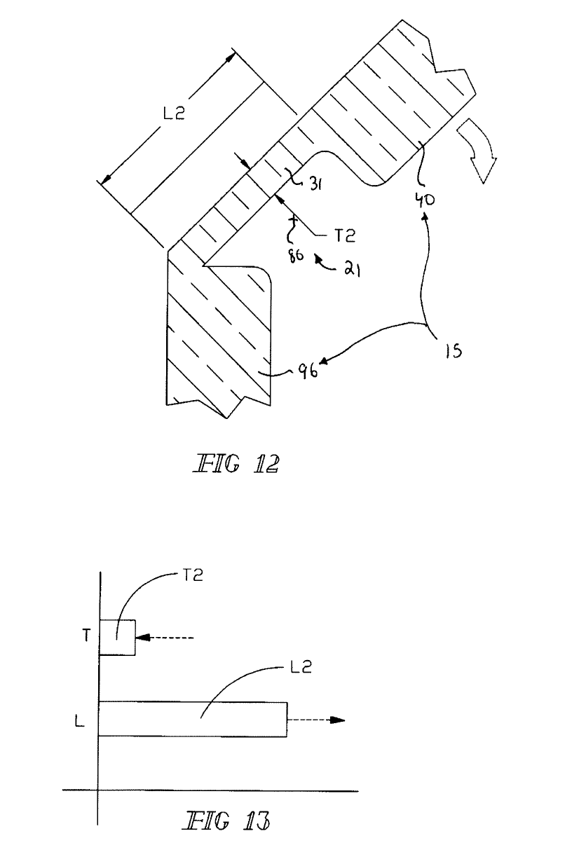

Continued erecting of left side closure 16 causes first crush web 31 to stretch as outer side wall 40 is folded about side-wall fold axis 86 relative to inner side wall 96 as shown in FIGS. 6 and 8 and in FIGS. 10 and 11. At this point, first crush web 31 has an intermediate first crush-web length L2 and an intermediate first crush-web thickness T2. In comparison, intermediate first crush-web length L2 is greater than initial first crush-web length L1 due to the stretching of first crush web 31 and intermediate first crush-web thickness T2 is less than initial first crush-web thickness T1 as shown in FIG. 13. Intermediate first crush-web thickness T2 is, for example, less than crushed thickness 66.

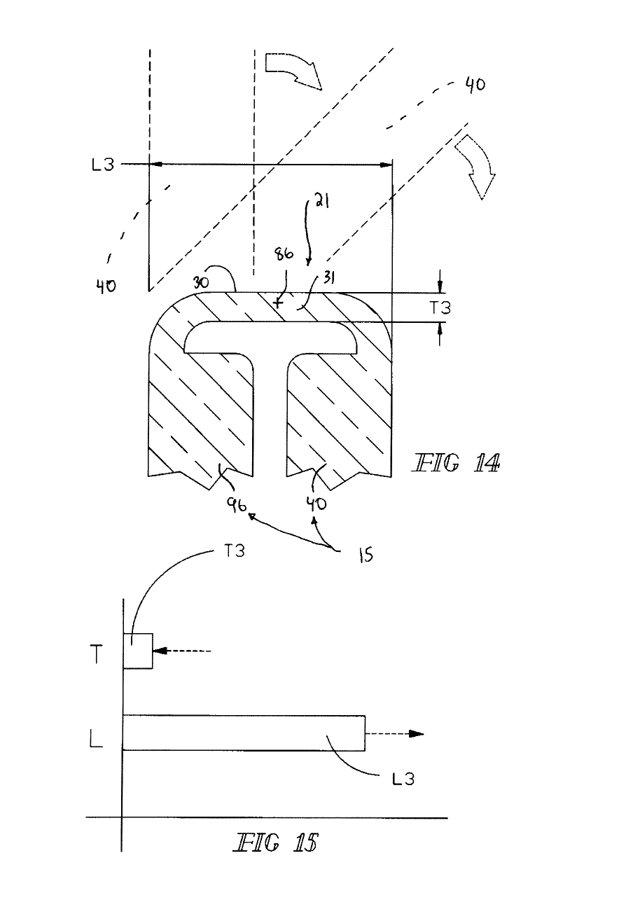

First crush web 31 elongates and thins further as folding of left side closure 16 is completed as shown in FIGS. 14 and 15. After folding is complete, first crush web 31 has a final first crush-web thickness T3 which is less than intermediate first cursh-web thickness T2. First crush web 31 also has a final first crush-web length L3 which is greater than intermediate first crush-web length L2. As a result of first crush web 31 elongating and thinning, relatively flat and uniform support surface 30 is established as a result. Relatively flat and uniform support surface 30 supports the second container thereon when the second container is stacked on container 10.

Second crush zone 22 is established as a result of forming second crush web 32 during the blank forming process diagrammatically shown in FIGS. 2A-2C. Second crush web 32 includes a crush-web portion 32A and another crush-web portion 32B as shown in FIGS. 16 and 17. Crush-web portion 32A is appended to outer-wall anchor flap 36 and is arranged to extend toward inner-wall anchor flap 37 and terminate at an anchor-flap cut line 120 formed between outer-wall anchor flap 36 and inner-wall anchor flap 37. Crush-web portion 32B is appended to inner-wall anchor flap 37 and is arranged to extend toward outer-wall anchor flap 36 and terminate at anchor-flap cut line 120. As an example, each crush-web portion 32A, 32B is about ⅛ inch wide.

Second crush zone 22 minimizes friction between inner-wall anchor flap 37 and outer-wall anchor flap 36 during initial erecting of left side closure 16. Inner-wall anchor flap 37 and outer-wall anchor flap 36 are positioned to lie next to one another prior to forming container 10. During the initial erecting of left side closure 16, outer-wall anchor flap 36 is folded about outer-wall anchor-flap fold line 38 in a counter-clockwise direction 122 as shown in FIG. 18. Second crush web 32 has crushed thickness 66 which causes the amount of surface area which is present along anchor-flap cut line 120 to be minimized thereby minimizing friction so that the machinery used to form container 10 does not bind or jam during forming of container 10.

Third crush zone 23 is established as a result of forming third crush web 33 during the blank forming process. Third crush web 33 is appended to outer-wall anchor flap 36 and is arranged to extend away from outer-wall anchor flap 36 toward outer-wall anchor-flap fold line 38 that is formed between outer side wall 40 and outer-wall anchor flap 36 as suggested in FIG. 2 and shown in FIG. 3. Third crush zone 23 minimizes resistance to folding outer-wall anchor flap 36 about outer-wall anchor-flap fold line 38 so that outer side wall 40 is not induced to moved away from inner side wall 96 after left side closure 16 is formed.

Fourth crush zone 24 is established as a result of forming fourth crush web 34 during the blank forming process. Fourth crush web 34 is arranged to interconnect and extend between outer section 116 and inner section 114 of tab strip 52 as shown in FIGS. 3 and 4. During folding of left side closure 16, outer section 116 is folded about tab-fold axis 118 toward floor 14 and fourth crush web 34 elongates and things to establish top surface 42 of stack tab 161. As a result of fourth crush web 34 thinning and elongating, top surface 42 of stack tab 161 is uniform and relatively flat so that first stack tab 161 mates with first stack-tab receiver 50 formed in floor 14 of the second container stacked on container 10. As shown in FIG. 24, fourth crush web 34 has a relatively thinner fourth crush web thickness 24T which is smaller that corrugated thickness 68.

Fifth crush zone 25 is also established as a result of forming fifth crush web 35 during the blank-forming process. Fifth crush web 35 is arranged to extend around a portion of perimeter 44 of tab aperture 46 as shown in FIGS. 3-6. Perimeter 44 includes a first segment 441, a bridge segment 442, and a second segment 443 as shown in FIG. 4. First, second, and bridge segments 441, 442, 443 of perimeter 44 cooperate to define tab aperture 46. First segment 441 is spaced apart from second segment 443. First and second segments 441, 443 extend outwardly away from side-wall fold axis 86 toward outer side wall 40. Bridge segment 442 extends between and interconnects first and second segments 441, 442 as shown in FIG. 4. Fifth crush web 35 is arranged to extend around bridge segment 442 to minimize friction between outer section 116 of tab strip 52 and perimeter 44. As shown in FIG. 25, fifth crush web 35 has a relatively thinner fifth crush web thickness 25T which is smaller that corrugated thickness 68.

First crush zone 21 is formed along a support surface 30 included in left side closure 16 as shown in FIG. 2. First crush zone 21 is configured to provide means for folding an outer side wall 40 about a side-wall fold axis 86 towards floor 14 of container 10 to cause support surface 30 along side-wall fold axis 86 to be flat and uniform so that a floor of a second container is supported on support surface 30 without causing the stack of containers to lean.

Second crush zone 22 is formed between an inner-wall anchor flap 37 included in left side closure 16 and an outer-wall anchor flap 36 included in left side closure 16 as illustrated in FIG. 2. Second crush zone 22 is configured to provide means for minimizing friction between inner-wall anchor flap 37 and outer-wall anchor flap 36 during an initial erecting of container 10 so that machinery used to form container 10 does not bind or jam during formation of container 10.

Another embodiment of a container is provided for carrying various items. As an example, the container has an external shape that is rectangular and an internal shape that is generally octagonal. The container is made from a blank including an a floor, a left side closure appended to the floor about a left-side fold line, a rear end wall appended to the floor about a rear-end fold line, a right side closure appended to the floor along a right-side fold line, an a front end wall appended to the floor along a front-end fold line.

The left side closure is substantially the same as the right side closure, and thus, only the left side closure will be discussed in detail. The left side closure includes an inner strip appended to the floor about the left-side fold line and an outer strip appended to the inner strip about a side-wall fold axis.

The outer strip includes an outer side wall and an outer-wall anchor flap that comprises an anchor-flap tab and a corner bridge interconnecting the outer side wall and the anchor-flap tab. The corner bridge is coupled to the rear end wall along an outer-wall anchor-flap fold line and to the anchor-flap tab along a tab fold line. The outer-wall anchor-flap fold line and the tab fold line are arranged to lie in spaced-apart generally parallel relation to one another. The corner bridge, as an example, has a generally rectangular shape. A similar corner bridge is also provided at the front left, rear left, and rear right portions of the blank. The outer side wall is coupled to the inner side wall about the side-wall fold axis.

The floor may be rectangular or octagonal. As an example, an octagon-shaped floor includes an end edge and a mitered edge that is arranged to interconnect the end edge and the left-side fold line. The end edge and the left-side fold line cooperate to define an obtuse included angle. As an example, the obtuse included angle is about 135 degrees. When folded, the corner bridge is arranged to confront (e.g., abut or lie alongside) the mitered edge to establish a mitered inside corner portion and the anchor-flap tab is arranged to confront (e.g., abut or lie alongside) the end edge.

The inner strip includes an inner side wall appended to the floor about the side-wall fold line, an inner-wall anchor flap appended to the inner side wall about an inner-wall anchor-flap fold line, and an auxiliary inner-wall anchor flap appended to the inner side wall about an auxiliary inner-wall anchor-flap fold line. When folded, the inner-wall anchor flap is arranged to confront (e.g., abut or lie alongside) the rear end wall of the container causing the rear end wall to be positioned between the inner-wall anchor flap and the anchor-flap tab of the outer-wall anchor flap.

In another embodiment, the corner bridge has a shape resembling an hourglass. The hour-glass shaped corner bridge includes an upper web, a lower web, and a medial web interconnecting the upper and lower webs. The outer-wall anchor-flap fold line and the tab fold line in this embodiment are both bow shaped. As an example, the outer-wall anchor-flap fold line and tab fold line each includes a first perforated segment a second perforated segment. Both segments may be straight or curved.

The first perforated segment of the outer-wall anchor flap fold line is arranged to curve outwardly away from the center bridge to produce a first top convex edge that is arranged to face toward outer side wall. The first perforated segment of the tab fold line is arranged to curve outwardly way from the center bridge to produce a second top convex edge that is arranged to face toward the tab. The first and second top convex edges cooperate to define the upper web therebetween.

The second perforated segment of the outer-wall anchor flap fold line is arranged to curve outwardly away from the center bridge to produce a first bottom convex edge that is arranged to face toward outer side wall. The second perforated segment of the tab fold line is arranged to curve outwardly way from the center bridge to produce a second bottom convex edge that is arranged to face toward the tab. The first and second bottom convex edges cooperate to define the lower web therebetween.

The upper web and the lower web both extend away from the medial web towards and into the interior region of the container. As a result, the corners of the container are reinforced providing for maximized stacking strength.

In yet another embodiment, a container is made from a blank including a floor, a left side wall appended to the floor about a left-side fold line, a rear end closure appended to the about a rear-end fold line, a right side wall appended to the floor along a right-side fold line, an a front end closure appended to the floor along a front-end fold line. This container is also known as a fold-over end-wall container.

The rear end closure is substantially the same as the front end closure, and thus, only the rear end closure will be discussed in detail. The rear end closure includes an inner strip appended to the floor about the rear-end fold line and an outer strip appended to the inner strip about an end-wall fold axis.

The outer strip includes an outer end wall and an outer-wall anchor flap. The inner strip includes an inner end wall and an inner-wall anchor flap. During folding of the container, the outer-wall anchor flap is coupled to an inner surface of the left side wall that is arranged to face toward the interior region of the container and the inner-wall anchor flap is coupled to an outer surface of the left side wall that is arranged to face opposite the inner surface. After the container has been folded, the left side wall is positioned to lie between the inner-wall and outer-wall anchor flaps. In this embodiment, left side wall and the right side wall each have a side wall length. The inner and outer end walls included in the rear and front closures each have an end wall length. As an example, the end wall length is less than the side wall length.

In another embodiment of a container, the inner-wall anchor flap is coupled to an outer surface of the rear end wall that is arranged to face away from the interior region of the container. The outer-wall anchor flap is coupled to the inner-wall anchor flap to cause the inner-wall anchor flap to be positioned to lie between the outer-wall anchor flap and the rear end wall causing a rear-end closure to be established. The front-end closure may be established in a similar manner. The rear end and front end closures of this embodiment are also called solid end closures.

Container 10 minimized difficulties in tray forming when used in the field. As a result, waste is minimized while revenue is maximized. Blank 11 is formed during an illustrative blank-forming process and is used during a container-forming process to form container 10. Blank 11 minimizes waste material formed during the blank-forming process. As waste material decreases, the likelihood of improperly forming containers increases. These improperly formed containers are also known as cripples. Blank 11 and resulting container 10 minimize waste while minimizing the number of cripples.

During the container-forming process, first crush zone 21 minimizes tension between inner side wall 96 and outer side wall 40. As a result, inner and outer side wall 96, 40 remain coupled to one another during container forming and minimizes waste as a result of inner and outer side walls de-coupling from one another. When glue is used to couple inner side wall 96 to outer side wall 40, minimized tension provides a maximized glue bond to be established between inner and outer side walls 40, 96.

First and third crush zones 21, 23 cooperate together to provide for a square-corner construction of each corner included in container 10. As an example, left-rear corner 28 has a square-corner construction which is useful for receiving rectangular-shaped primary packages therein such as clamshell containers and for minimizing uneven stacking surfaces from misalignment of anchor flaps 36, 37. As a result of tension between inner and outer side walls 40, 96 being minimized and tension between outer side wall 40 and outer-wall anchor flap 36 being minimized, binding and bunching along outer-wall anchor-flap fold line 38 is minimized. At the same time, outer-wall anchor flap 36 is positioned to lie in interior 26 and not extend beyond support surface 30 which is also known as flagging.

As an illustrative example, inner side wall 96 is coupled to outer side wall 40 by a first crush web 31. First crush web 31 includes a series of spaced apart first crush-web segments 31A, 31B, 31C, 31D, 31E, 31F, and 31G as shown in FIG. 4. Between each first crush-web segment 31A, 31B, 31C, 31D, 31E, 31F, and 31G is an associated weakness area 41A, 41B, 41C, and 41D. Each weakness area 41A, 41B, 41C, and 41D may be a cut or preformation which minimizes tension between inner and outer side walls 40, 96.

In one example of a container-forming process which is performed by a container-forming machine, blank 11 is transferred into an erecting section of the container-forming machine. As blank 11 is transferred, the machine forces outer sections 116 of each tab strip 52 out of associated tab aperture 46 formed in outer side wall 40 toward floor 14. As the container-forming process continues, rear end wall 18 and front end wall 12 are arranged to lie in generally perpendicular relation to floor 14. Inner side wall 96, 296 are arranged to lie in generally perpendicular relation to floor 14 and inner-wall anchor flaps 37, 237 are arranged to abut rear end wall 18. Outer side wall 40 is then folded about 180 degrees relative to inner side wall 96 so that outer side wall 40 lies parallel to and in confronting relation with inner side wall 96.

As outer side wall 40 is folded relative to inner side wall 96, first crush web 31 is stretched about side-wall fold axis 86 so that support surface 30 is established. Also during folding of outer side wall 40 relative to inner side wall 96, retention flanges 131, 132 included in outer section 116 of tab strip 52 are trapped between inner and outer side walls 40, 96. At the same time, outer-wall anchor flap 36 is back folded perpendicular to outer side wall 40 so that as outer side wall 40 is rotated towards floor 14, outer-wall anchor flap 36 is arranged to lie in confronting relation with rear end wall 18. Both base edges of inner-wall and outer-wall anchor flaps 36, 37 after folding are arranged to lie flush with floor 14 and associated side walls 40, 96 are arranged to lie at a slight incline so that an acute angle is formed between side walls 40, 96 and floor 14.

First crush zone 21 results from forming first crush web 31 between inner and outer side walls 40, 96. As an example, side-wall fold axis 86 is centered between inner and outer side walls 40, 96. After forming of container 10, support surface 30 is established by the stretching of first crush web 31. As an example, first crush web 31 has a width greater than about 10 point and is sized according to the corrugated material in use.

A method of making article-transport container 10 includes the steps of cutting a corrugated sheet 54 to provide an intermediate blank, crushing a first portion of the intermediate blank to form first crush web 31 and establish blank 11, folding blank 11, deforming the first crush web 31, and coupling portions of blank 11 together to establish article-transport container 10. The cutting step cuts corrugated sheet 54 to provide an intermediate blank having floor 14 having first and second ends 74, 76, left side closure 16 including inner strip 82 coupled to floor 14 about left-side fold line 70, outer strip 84 coupled to inner strip 82 about side-wall fold axis 86, and front end wall 12 coupled to floor 14 about front end fold line 76. Intermediate blank has corrugated thickness 68.

The crushing step crushes a first portion of the intermediate blank to form first crush web 31 as an example. First crush web 31 is arranged to lie between inner strip 82 and outer strip 84 along side-wall fold axis 76. First crush web 31 has relatively thinner initial first crush-web thickness T1 and initial first crush-web length L1 as shown in FIGS. 10 and 11.

The folding step folds blank 11 to cause left side closure 16 to fold about left-side fold line 70 toward floor 14 to extend in an upward direction away from floor 14. Outer strip 84 is folded about side-wall fold axis 86 toward floor 14 and inner strip 82 to cause outer strip 84 to lie in confronting relation with inner strip 82 as shown in FIGS. 7 and 8.

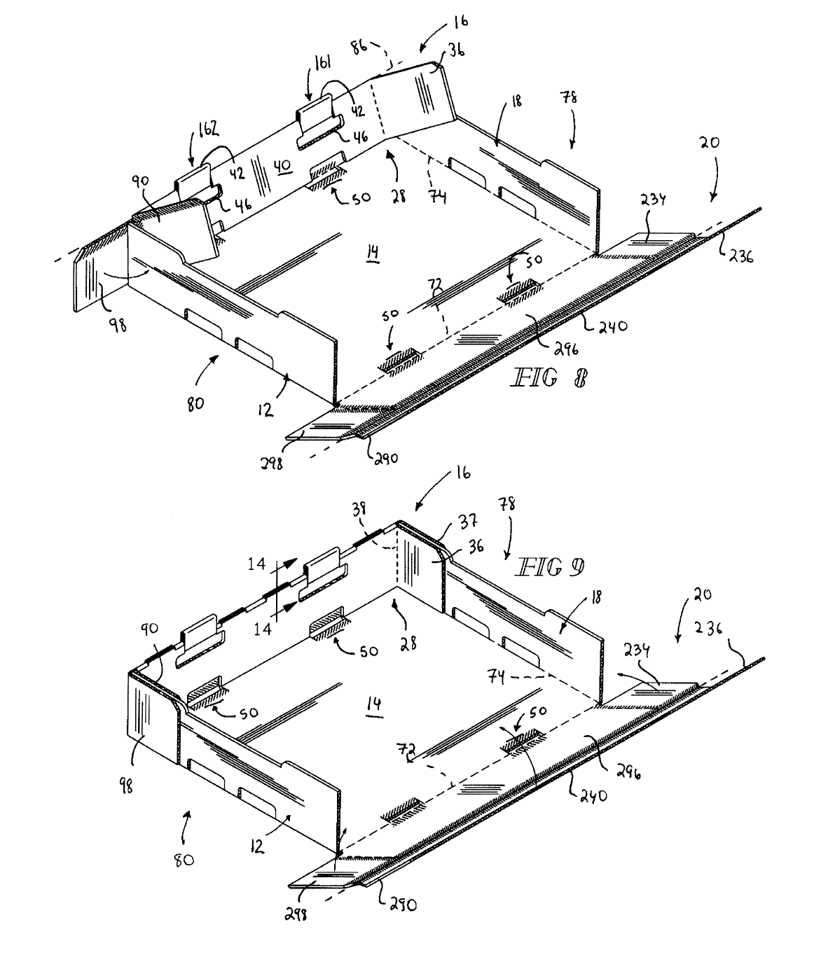

The deforming step deforms first crush web 31 during the folding step to cause the first crush web 31 to have relatively smaller final first crush-web thickness T3 and relatively longer final first crush-web length L3. As a result, a flat, uniform support surface to cause to establish flat, uniform support surface 30 along portions of side-wall fold axis 86. The coupling step couples portions of inner strip 82 and outer strip 84 to front end wall 12 as shown, for example, in FIGS. 8 and 9.

1. An article-transport container comprising
a floor having first and second sides and first and second ends and
a border coupled to the floor and arranged to cooperate with the floor to form an interior region adapted to contain articles therein, the border including a left side closure coupled to the first side of the floor along a left-side fold line, a right side closure coupled to the second side of the floor along a right-side fold line, a front end wall coupled to the first end of the floor along a front-end fold line, and a rear end wall coupled to the second end of the floor along a rear-end fold line,
wherein the left side closure includes an inner strip coupled to the floor about the left-side fold line, an outer strip coupled to the inner strip about a side-wall fold axis, and a first crush web configured to provide means for establishing a first crush zone prior to container forming that interconnects the outer strip to the inner strip to cause the outer strip to fold about the side-wall fold axis toward the floor to cause a flat, uniform support surface to be established along portions of the side-wall fold axis during container forming so that a floor of a second container may be supported on the flat, uniform support surface without causing leaning of a stack including the first container and the second container.

2. The article-transport container of claim 1, wherein the first crush web extends and interconnects the outer strip and the inner strip along the side-wall fold axis.

3. The article-transport container of claim 2, wherein the outer strip and the inner strip have a corrugated thickness and the first crush web has a relatively smaller first crush web thickness.

4. The article-transport container of claim 3, wherein the first crush web includes a first crush-web portion coupled to the inner strip to extend away from the inner strip toward the outer strip and a second crush-web portion coupled to the outer strip to extend away from the outer strip toward the inner strip and the side-wall fold axis is arranged to lie between the first crush-web portion and the second crush-web portion.

5. The article-transport container of claim 1, wherein the inner strip includes an inner side wall coupled to the floor about the left-side fold line and an inner-wall anchor flap coupled to the inner side wall along an inner-wall anchor-flap fold line and the outer strip includes an outer side wall coupled to the inner side wall along the side-wall fold axis and an outer-wall anchor flap coupled to the outer side wall along an outer-wall anchor-flap fold line.

6. The article-transport container of claim 5, wherein the left side closure further includes a second crush web configured to provide means for establishing a second crush zone prior to container forming that minimizes an amount of surface area between the inner-wall anchor flap and the outer-wall anchor flap to cause friction to be minimized during container forming so that binding during container forming is minimized as a result.

7. The article-transport container of claim 6, wherein the second crush web is positioned to lie between the inner-wall anchor flap and the outer-wall anchor flap and extend along the side-wall fold axis.

8. The article-transport container of claim 7, wherein the outer-wall anchor flap and the inner-wall anchor flap each have a corrugated thickness and the second crush web has a relatively smaller second crush web thickness.

9. The article-transport container of claim 8, wherein the second crush web includes a crush-web portion coupled to the outer-wall anchor flap to extend away from the outer-wall anchor flap toward the inner-wall anchor flap, another crush-web portion coupled to the inner-wall anchor flap to extend away from the inner-wall anchor flap toward the outer-wall anchor flap, and an anchor-flap cut line positioned to lie between and separate the inner-wall anchor flap from the outer-wall anchor flap to cause the inner-wall anchor flap to move relative to the outer-wall anchor flap.

10. The article-transport container of claim 1, wherein the inner strip includes an inner side wall coupled to the floor about the left-side fold line and an inner-wall anchor flap coupled to the inner side wall along an inner-wall anchor-flap fold line, the outer strip includes an outer side wall coupled to the inner side wall along the side-wall fold axis and an outer-wall anchor flap coupled to the outer side wall along an outer-wall anchor-flap fold line, and the outer strip further includes a third crush web configured to provide means for establishing a third crush zone that minimizes resistance to folding of the outer-wall anchor flap about the outer-wall anchor-flap fold line so that the outer side wall is not biased to moved away from the inner side wall after the left side closure is formed during container forming.

11. The article-transport container of claim 10, wherein the third crush web is appended to the outer-wall anchor flap and arranged to extend away from the outer-wall anchor flap toward the outer-wall anchor-flap fold line that is formed between the third crush web and the outer side wall.

12. The article-transport container of claim 1, wherein the inner strip includes an inner side wall coupled to the floor about the left-side fold line and an inner-wall anchor flap coupled to the inner side wall along an inner-wall anchor-flap fold line, the outer strip includes an outer side wall coupled to the inner side wall along the side-wall fold axis, an outer-wall anchor flap coupled to the outer side wall along an outer-wall anchor-flap fold line, and a tab strip including an inner section coupled to the inner side wall in a fixed position relative to the inner side wall and an outer section coupled to the inner section and trapped between the inner side wall and the outer side wall.

13. The article-transport container of claim 12, wherein the tab strip further includes a fourth crush web configured to provide means for establishing a fourth crush zone that interconnects the inner section of the tab strip and the outer section of the tab strip to cause the outer section to fold about a tab-fold axis toward the floor of the container during container forming to form a first stack tab that includes a flat, uniform top surface so that the first stack tab mates with a first stack-tab receiver formed in the floor of the second container when the second container is stacked on top of the container.

14. The article-transport container of claim 13, wherein the fourth crush web extends between and interconnects the outer section of the tab strip and the inner section of the tab strip along the tab-fold axis.

15. The article-transport container of claim 14, wherein the outer section and the inner section each have a corrugated thickness and the fourth crush web has a relatively smaller fourth crush web thickness.

16. The article-transport container of claim 12, wherein the inner side wall is formed to include a fifth crush web configured to provide means establishing a fifth crush zone that minimizes an amount of surface area between the outer section of the tab strip and a perimeter defining a tab aperture formed in the inner side wall to cause friction to be minimized during container forming so that binding is minimized as a result.

17. The article-transport container of claim 16, wherein the fifth crush web is formed along the perimeter of the tab aperture.

18. The article-transport container of claim 17, wherein the inner side wall has a corrugated thickness and the fifth crush web has a relatively smaller fifth crush web thickness.

19. An article-transport container comprising
a floor having first and second sides and first and second ends and
a border coupled to the floor and arranged to cooperate with the floor to form an interior region adapted to contain articles therein, the border including a left side closure coupled to the first side of the floor along a left-side fold line, a right side closure coupled to the second side of the floor along a right-side fold line, a front end wall coupled to the first end of the floor along a front-end fold line, and a rear end wall coupled to the second end of the floor along a rear-end fold line,
wherein the left side closure includes an inner strip including an inner side wall coupled to the floor about the left-side fold line and an inner-wall anchor flap coupled to the inner side wall along an inner-wall anchor-flap fold line, a first crush web arranged to extend between and interconnect the inner strip and an outer strip included in the left side closure along a side-wall fold axis arranged to lie in parallel spaced-apart relation of the left-side fold line and the first crush web has an initial first crush-web thickness that is smaller than a thickness of the inner strip prior to container forming and a final first crush web thickness that is smaller than the initial first crush-web thickness after container forming, and a second crush web configured to provide means for establishing a second crush zone prior to container forming that minimizes an amount of surface area between the inner-wall anchor flap and an outer-wall anchor flap included in the outer strip to cause friction to be minimized during container forming so that binding during container forming is minimized as a result, the outer strip including an outer side wall coupled to the inner side wall along the side-wall fold axis, the outer-wall anchor flap coupled to the outer side wall along an outer-wall anchor-flap fold line, a third crush web configured to provide means for establishing a third crush zone that minimizes resistance to folding of the outer-wall anchor flap about the outer-wall anchor-flap fold line so that the outer side wall is not biased to moved away from the inner side wall after the left side closure is formed during container forming.

20. A method of making an article-transport container, the method comprising the steps of
cutting a sheet to provide an intermediate blank including a floor having first and second sides and first and second ends, a left side panel including an inner strip coupled to the floor about a left-side fold line and an outer strip coupled to the inner strip about a side-wall fold axis, and a front end wall coupled to the floor about a front end fold line, the intermediate blank having a corrugated thickness,
crushing a first portion of the left side panel to form a first crush web in the intermediate blank, the first crush web being arranged to lie between the inner strip and the outer strip along the side-wall fold axis, the first crush web having an initial first crush web length and an initial first crush-web thickness that is smaller than the corrugated thickness,
folding the intermediate blank to cause the left side panel to fold about the left-side fold line toward the floor to extend in an upward direction away from the floor, the outer strip to fold about the side-wall fold axis toward the floor and the inner strip to cause the outer strip to lie in confronting relation with the inner strip,
deforming the first crush web during the folding step to cause the first crush web to have a relatively smaller final first crush web thickness and a relatively longer final first crush web length and to establish a flat, uniform support surface along portions of the side-wall fold axis, and
coupling portions of the inner strip and the outer strip to the front end wall to establish a first article-transport container.
